(19) United States
(12) Patent Application Publication
(10) Pub. No.: US 2007/0269718 A1
(43) Pub. Date: Nov. 22, 2007

(54) ELECTRODE COMPOSITION, METHOD OF MAKING THE SAME, AND LITHIUM ION BATTERY INCLUDING THE SAME

(75) Inventors: Larry J. Krause, Stillwater, MN (US); Lowell D. Jensen, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/419,564

(22) Filed: May 22, 2006

(51) Int. Cl. H01M 4/62

(52) U.S. Cl. 429/232; 429/217; 252/182.1

(57) ABSTRACT

An electrode composition for a lithium ion battery comprises a binder, electrochemically active particles, metallic conductive diluent particles, and non-metallic conductive diluent particles. The electrochemically active particles and the metallic conductive diluent particles do not share a common phase boundary, and are present in a molar ratio less than or equal to 3. Methods of making the electrode composition and lithium ion batteries using the same are also disclosed.

### BACKGROUND

Lithium ion batteries generally have a negative electrode (anode), a counterelectrode (cathode), and electrolyte separating the anode and the cathode.

Anodes based upon electrochemically active main group metals (e.g. Sn, Si, Al, Bi, Ge, or Pb) for lithium ion batteries are currently of significant interest worldwide. Metal and alloy based anodes offer advantages over conventional graphite electrodes such as, for example, increased energy density.

In general, anodes based upon electrochemically active metals exhibit a large volume change that the metals and their alloys undergo as they store lithium. The volume of the active metal or alloy bearing the active metal can change by as much as 200 percent as the electrode undergoes charge and discharge. Much of the activity in this area centers upon the synthesis of non-crystalline or amorphous alloys containing, for example, tin and silicon. Synthetic methods for manufacturing such alloys typically involve sophisticated and/or tedious processes.

For use in lithium ion batteries, negative electrodes are typically fabricated on a current collector such as, for example, copper foil. In making the negative electrode the active material is typically combined with a high surface area carbon and an organic polymeric material that serves as a binder to hold the mixture together. The negative electrode is typically formed by coating the active material, carbon, and binder from solvent onto the current collector, and then drying the coating to remove the solvent.

### SUMMARY

In one aspect, the present invention provides an electrode composition for a lithium ion battery comprising:

a binder comprising polyimide and having dispersed therein:

electrochemically active particles;

metallic conductive diluent particles that are not electrochemically active,

wherein the electrochemically active particles and the conductive diluent particles do not share a common phase boundary; and

non-metallic conductive diluent particles,

wherein the electrochemically active particles and the metallic conductive diluent particles are present in a molar ratio in a range of from greater than zero and less than or equal to 3.

Electrode compositions according to the present invention are useful, for example, in the manufacture of lithium ion batteries. Hence, in another aspect, the present invention provides a lithium ion battery comprising:

an anode comprising an electrode composition according to claim 1;

a cathode; and

electrolyte separating the anode and cathode.

In another aspect, the present invention provides a method of making an electrode composition, the method comprising:

a) providing components comprising:

electrochemically active particles;

metallic conductive diluent particles that are not electrochemically active, wherein the electrochemically active particles and the conductive diluent particles do not share a common phase boundary; and

non-metallic conductive diluent particles;

wherein the electrochemically active particles and the metallic conductive diluent particles are present in a molar ratio in a range of from greater than zero and less than or equal to 3; and

b) dispersing the components in a binder comprising polyimide.

In some embodiments, the electrochemically active particles comprise silicon. In some embodiments, the electrochemically active particles consist essentially of silicon. In some embodiments, the electrochemically active particles have an average particle size in a range of from 0.5 to 1.5 micrometer. In some embodiments, the metallic conductive diluent particles have an average particle size in a range of from 0.5 to 1.5 micrometers. In some embodiments, the metallic conductive diluent particles are selected from the group consisting of tungsten silicide particles, titanium silicide particles, molybdenum silicide particles, copper particles, and combinations thereof. In some embodiments, the non-metallic conductive particles comprise high surface area carbon. In some embodiments, the electrochemically active particles and the metallic conductive diluent particles are present in a molar ratio of from 0.5 to 1.5. In some embodiments, the polyimide comprises an aromatic polyimide.

Electrode compositions according to the present invention are typically easy and relatively inexpensive to fabricate, and typically perform well as anodes in lithium ion batteries.

As used herein:

The term “anode” refers to the electrode where electrochemical oxidation occurs during the discharging process (i.e., during discharging, the anode undergoes delithiation, and during charging, lithium atoms are added to this electrode).

The term “cathode” refers to the electrode where electrochemical reduction occurs during the discharging process (i.e., during discharging, the cathode undergoes lithiation, and during charging, lithium atoms are removed from this electrode).

The term “charging” refers to a process of providing electrical energy to an electrochemical cell.

The term “conductive” means having a bulk resistivity at 20° C. of less than 1 microohm-centimeter (μΩ-cm).

The term “discharging” refers to a process of removing electrical energy from an electrochemical cell (i.e., discharging is a process of using the electrochemical cell to do useful work).

The term “electrically active” as used with metals or metal alloys refers to metals or metal alloys that can incorporate lithium in their atomic lattice structure.

The term “lithiation” refers to the process of inserting lithium into an active electrode material in an electrochemical cell. During the lithiation process an electrode undergoes electrochemical reduction; the term “delithiation” refers to the process of removing lithium from an active electrode material in an electrochemical cell. During the delithiation process an electrode undergoes electrochemical oxidation.

The term “metallic” means having a composition that contains at least one type of metal atom or ion.

Elemental silicon is to be considered a metal within the meaning of the term metallic.

The term “nonconductive” means having a bulk resistivity at 20° C. of greater than or equal to 1 microohm-centimeter.

The term “non-metallic” means having a composition that does not contain at least one type of metal atom or ion.

### BRIEF DESCRIPTION OF THE DRAWING

FIG. 1 is an exploded perspective view of an exemplary lithium ion battery according to the present invention;

FIG. 2 is a graph showing the specific capacity of the electrode composition of Example 1;

FIG. 3 is a graph showing the capacity retention of the electrode composition of Example 1;

FIG. 4 is a graph showing the specific capacity of the electrode composition of Example 2;

FIG. 5 is a graph showing the specific capacity of the electrode composition of Example 3;

FIG. 6 is a graph showing the specific capacity of the electrode composition of Example 4; and

FIG. 7 is a graph showing the specific capacity of the electrode composition of Example 5.

### DETAILED DESCRIPTION

Electrode compositions according to the present invention that may be used, for example, as anodes in lithium ion batteries comprise a binder having dispersed therein electrochemically active particles, metallic conductive diluent particles, and non-metallic conductive particles.

The electrochemically active particles comprise electrochemically active metals or metal alloys that are capable of incorporating lithium atoms into their atomic lattice structure. Examples of electrochemically active metals include silicon, tin, antimony, magnesium, zinc, cadmium, indium, aluminum, bismuth, germanium, lead, alloys thereof, and combinations of the foregoing. Examples of electrochemically active metal alloys include: alloys containing silicon, tin, a transition metal and, optionally carbon; alloys containing silicon, a transition metal, and aluminum; alloys containing silicon, copper, and silver; and alloys containing tin, silicon or aluminum, yttrium, and a lanthanide or an actinide or a combination thereof. In some particularly useful embodiments, the electrochemically active particles may comprise, or even consist essentially of, silicon (e.g., silicon powder).

Typically, the electrochemically active particles have an average particle size in a range of from 0.5 to 50 micrometers; for example, in a range of from 0.5 to 20 micrometers or in a range of from 0.5 to 5 micrometers, or even in a range of from 0.5 to 1.5 micrometers. However, average particle sizes outside of this range may also be used.

In some embodiments, the electrochemically active particles have an average crystalline domain size of greater than 0.15, 0.2, or even greater than 0.5 micrometer. In some useful embodiments, the average crystalline domain size is in a range of from 0.15 to 0.2 micrometer.

In some embodiments, the electrochemically active particles are isotropic and/or homogeneous, although this is not a requirement.

In the absence of solvent, electrode compositions according to the present invention typically comprise at least 10 percent by weight of the electrochemically active particles, based on the total weight of the electrode composition, although lesser amounts may also be used. For example, in the case of silicon particles, the amount of silicon particles is typically in a range of from 10 to 30 percent by weight, with correspondingly higher weight percentages being typically used for electrochemically active particles with higher densities.

The metallic conductive diluent particles are not electrochemically active. Exemplary metallic conductive diluent particles include particles comprising at least one of iron, nickel, titanium, titanium carbide, zirconium carbide, hafnium carbide, titanium nitride, zirconium nitride, hafnium nitride, titanium boride, zirconium boride, hafnium boride, chromium carbide, molybdenum carbide, tungsten carbide, chromium boride, molybdenum boride, tungsten boride, tungsten silicide particles, titanium silicide particles, molybdenum silicide particles, copper particles or vanadium silicide, and combinations thereof.

In general, the metallic conductive diluent particles have an average particle size in a range of from 0.5 to 20 micrometers, for example, in a range of from 0.5 to 10 or in a range of from 0.5 to 1.5 micrometers, although sizes outside of these ranges may also be used. The electrochemically active particles and the conductive diluent particles are discrete particles and do not form integral particles that share a common phase boundary.

The electrochemically active particles and the metallic conductive diluent particles are generally present in a molar ratio in a range of from greater than zero up to less than or equal to 3; that is, the number of moles of electrochemically active particles divided by the number of moles of metallic conductive diluent particles is in a range of from greater than zero and less than or equal to 3.

For example, the molar ratio of electrochemically active particles to metallic conductive diluent particles may be in a range of from 0.5 to 1.5, typically in a range of from 0.5 to 1.0, and more typically in a ratio of from 1.0 to 1.5.

The electrode composition may optionally include an adhesion promoter that promotes adhesion of the silicon particles or electrically conductive diluent to the polymeric binder. The combination of an adhesion promoter and a polyimide binder may help the binder better accommodate volume changes that may occur in the powdered material during repeated lithiation/delithiation cycles.

If used, an optional adhesion promoter may be added to the electrically conductive diluent, and/or may form part of the binder (e.g., in the form of a functional group), and/or or may be in the form of a coating applied to the surface of the silicon particles. Examples of adhesion promoters are described in U. S. Publ. Pat. Appl. No. 2004/0058240 A1 (Christensen).

The non-metallic (i.e., not containing metal atoms) electrically conductive diluent particles typically have an average particle size in a range of 0.05-0.1 micrometers, although sizes outside this range may also be used. Typically the amount of non-metallic (i.e., not containing metal atoms) electrically conductive diluent particles is in a range of from 2 to 40 percent by weight of the electrode composition, although other amounts may also be used. Exemplary non-metallic electrically conductive diluents include, for example, carbon blacks such as those available as “SUPER P” and “SUPER S” from Timcal, Brussels, Belgium, as “SHAWANIGAN BLACK” from Chevron Chemical Co., Houston, Tex., acetylene black, furnace black, lamp black, graphite, carbon fibers and combinations thereof.

The binder comprises polyimide. The electrochemically active particles and conductive diluent particles, optional adhesion promoter, and optional non-metallic conductive diluent particles are typically dispersed in a binder that comprises a polyimide.

Typically, polyimides may be prepared via a condensation reaction between a binder precursor such as, for example, an aromatic dianhydride and a diamine in an aprotic polar solvent such as N-methylpyrrolidinone. This reaction leads to the formation of an aromatic polyamic acid, and subsequent chemical or thermal cyclization leads to a polyimide. A variety of other suitable polyimides are described in commonly-assigned co-pending U.S. patent application Ser. No. 11/218,448, entitled “Polyimide Electrode Binders”, filed Sep. 1, 2005 (Krause et al.), the disclosure of which is incorporated herein by reference, which includes a class of aliphatic or cycloaliphatic polyimide binders that have repeating units having the formula:

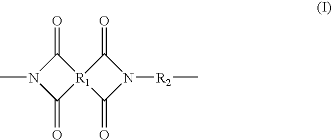

where:

R₁ is aliphatic or cycloaliphatic and

R₂ is aromatic, aliphatic or cycloaliphatic.

The R₁ and R₂ moieties in Formula I may be further substituted with groups that do not interfere with the use of the polyimide binder in a lithium ion cell. For example, when substituents are present on R₁, the substituents are typically electron-donating rather than electron-withdrawing groups. Polyimides also useful in this invention are described in D. F. Loncrini and J. M. Witzel, Polyarleneimides of meso-and d,1-1,2,3,4-Butanetetracarboxylic Acid Dianhydrides, Journal of Polymer Science, Part A-1, Vol. 7, 2185-2193 (1969); Jong-Young Jeon and Tae-Moon Tak, Synthesis of Aliphatic-Aromatic Polyimides by Two-Step Polymerization of Aliphatic Dianhydride and Aromatic Diamine, Journal of Applied Polymer Science, Vol. 60, 1921-1926 (1995); Hiroshi Seino et al., Synthesis ofAliphatic Polyimides Containing Adamantyl Units, Journal of Polymer Science: Part A: Polymer Chemistry, Vol. 37, 3584-3590 (1999); Hiroshi Seino et al., High Performance Polymers, Vol. 11, 255-262 (1999), T. Matsumoto, High Performance Polymers, Vol. 13 (2001), E. Schab-Balcerzak et al., Synthesis and characterization of organ osoluble aliphatic-aromatic copolyim ides based on cycloaliphatic dianhydride, European Polymer Journal, Vol. 38, 423-430 (2002); Amy E. Eichstadt et al., Structure-Property Relationships for a Series of Amorphous Partially Aliphatic Polyimides, Journal of Polymer Science: Part B: Polymer Physics, Vol. 40, 1503-1512 (2002) and Xingzhong Fang et al., Synthesis andproperties ofpolyimides derivedfrom cis-and trans-1,2,3,4-cyclohexanetetracarboxylic dianhydrides, Polymer, Vol. 45, 2539-2549 (2004). The polyimide may be capable of electrochemical charge transport when evaluated, for example, as described by L. J. Krause et al. in “Electronic Conduction in Polyimides”, J. E. Electrochem. Soc., Vol. 136, No. 5, May 1989. One useful polyimide may be obtained from a polyimide precursor commercially available as “PYRALIN PI 2555” from HD Microsystems, Santa Clara, Calif., and which may be activated (i.e., to form polyimide) by heating, in stages, to 300° C. at which temperature it is held for 60 minutes.

Electrode compositions may be prepared, for example, by milling the electrochemically active material, silicon, the metal(s), and a carbon source (e.g., graphite) under high shear and high impact for an appropriate period of time. Milling may be accomplished, for example, using a planetary mill. The electrode composition may be formed into an electrode by any suitable method, including, for example, forming a dispersion of the electrochemically active particles, metallic non-electrochemically active conductive particles, and nonmetallic conductive particles and a polyimide binder precursor (e.g., as available as “PYRALIN PI 2555”) in a solvent, casting the dispersion, removing the solvent, and heating the polyimide precursor to form polyimide.

One exemplary electrode composition has about 0.3 g of silicon, 0.88 g of titanium disilicide, 0.17 g of polyimide, and 0.25 g of high surface area carbon.

The electrode composition may be formed into an electrode (e.g., by pressing) or, more typically, by depositing from a liquid vehicle onto a current collector (e.g., a foil, strip, or sheet) to form an electrode. Examples of suitable materials for the current collector include metals such as copper, chromium, nickel, and combinations thereof. Typically, a small amount of a dispersant solvent such as N-methylpyrrolidinone (NMP) is added to make a slurry. The slurry is then typically mixed in a high speed mill followed by coating onto the current collector, and then dried for about 1 hour at about 75° C. followed by higher temperature treatment, for example, at 200° C. for about another hour. The purpose of the high temperature treatment is to form the binder from the binder precursor (for example polyimide) when a precursor is used, and to promote adhesion of the binder to the current collector.

The electrodes may be used, for example, as anodes or cathodes in batteries. The electrode compositions are particularly useful as anodes for lithium ion batteries.

Electrode compositions according to the present invention are typically useful as anodes for lithium-ion batteries. To prepare a lithium-ion battery, an anode is typically combined with an electrolyte and a cathode in a housing; for example, as described in U.S. Publ. Pat. Appln. No. 2006/0041644 (Obrovac). Electrode compositions according to the present invention may be used as anodes in lithium ion batteries.

Any lithium-containing material or alloy can be used as the cathode material in the batteries according to the present invention. Examples of suitable cathode compositions for liquid electrolyte-containing batteries include LiCoO₂, LiCo_{0.2}Ni_{0.8}O₂, and Li_{1.07}Mn_{1.93}O₄. Examples of suitable cathode compositions for solid electrolyte-containing batteries include LiV₃O₈, LiV₂O₅, LiV₃O₁₃, and LiMnO₂. Other examples of cathode compositions useful in the batteries according to the present invention can be found in U. S. Publ. Pat. Appln. Nos. 2003/0027048 A1 (Lu et al.); 2005/0170249 A1 (Lu et al.); 2004/0121234 A1 (Lu); 2003/0108793 A1 (Dahn et al.); 2005/0112054 A1 (Eberman et al.); 2004/0179993 A1 (Dahn et al.); and U.S. Pat. No. 6,680,145 B1 (Obrovac et al.); and U.S. Pat. No. 5,900,385 A1 (Dahn et al.); the disclosures of which are incorporated herein by reference.

The electrolyte may be liquid or solid. Useful electrolytes typically contain one or more lithium salts and a charge carrying medium in the form of a solid, liquid or gel. Exemplary lithium salts are stable in the electrochemical window and temperature range (e.g. from about −30° C. to about 70° C.) within which the cell electrodes may operate, are soluble in the chosen charge-carrying media, and perform well in the chosen lithium-ion cell. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, combinations thereof and other lithium salts that will be familiar to those skilled in the art.

Exemplary charge carrying media are stable without freezing or boiling in the electrochemical window and temperature range within which the cell electrodes may operate, are capable of solubilizing sufficient quantities of the lithium salt so that a suitable quantity of charge can be transported from the positive electrode to the negative electrode, and perform well in the chosen lithium-ion cell.

Useful solid charge carrying media include polymeric media such as, for example, polyethylene oxide.

Exemplary liquid charge carrying media include ethylene carbonate, propylene carbonate, dimethyl carbonate, diethyl carbonate, ethyl-methyl carbonate, butylene carbonate, vinylene carbonate, fluorinated ethylene carbonate, fluorinated propylene carbonate, γ-butylrolactone, methyl difluoroacetate, ethyl difluoroacetate, dimethoxyethane, diglyme (i.e., bis(2-methoxyethyl) ether), tetrahydrofuran, dioxolane, combinations thereof and other media that will be familiar to those skilled in the art. Exemplary charge carrying media gels include those described in U.S. Pat. No. 6,387,570 (Nakamura et al.) and U.S. Pat. No. 6,780,544 (Noh), the disclosures of which are incorporated herein by reference.

The charge carrying media solubilizing power may be improved through addition of a suitable co-solvent. Exemplary co-solvents include aromatic materials compatible with Li-ion cells containing the chosen electrolyte. Representative co-solvents include toluene, sulfolane, dimethoxyethane, combinations thereof and other co-solvents that will be familiar to those skilled in the art.

The electrolyte may include other additives that will be familiar to those skilled in the art. For example, the electrolyte may contain a redox chemical shuttle such as those described in U.S. Pat. No. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al.), U.S. Pat. No. 6,004,698 (Richardson et al.), U.S. Pat. No. 6,045,952 (Kerr et al.), and U.S. Pat. No. 6,387,571 B1 (Lain et al.); in U.S. patent application Ser. No. 11/094,927, filed Mar. 31, 2005 entitled, “Redox Shuttle for Rechargeable Lithium-ion Cell”, the disclosures of which are incorporated herein by reference, and in PCT Published Patent Application No. WO 01/29920 A1 (Richardson et al. '920).

Batteries may be in the form of cans with rolled up anode and cathode films, coin-cells, or other configurations. Typically, testing of electrodes is done in coin-type test cells. Typically, a separator film such as, for example, microporous materials such as those available as “CELGARD 2500” from Celanese Corp., Dallas, Tex., or any other porous polymer film can be used to separate the anode film from the cathode film, preventing shorts.

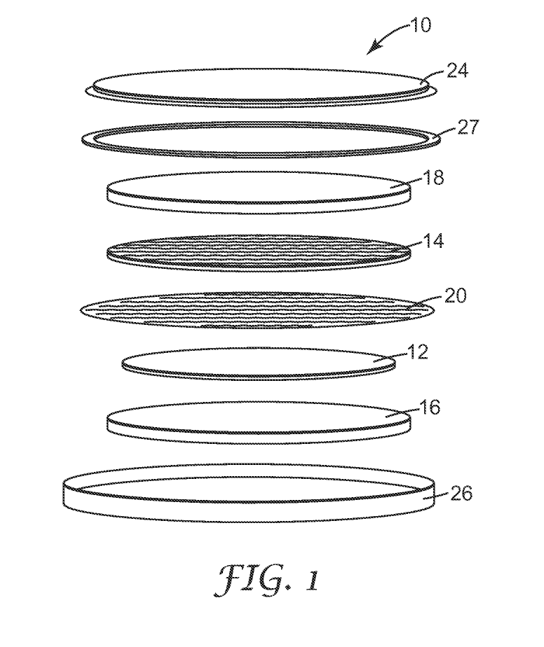

Exemplary coin-type test cells can be built in 2325 coin cell hardware as described in A. M. Wilson and J. R. Dahn, J. Electrochem. Soc., 142, 326-332 (1995). An exploded perspective schematic view of an exemplary 2325 coin cell 10 is shown in FIG. 1. Stainless steel cap 24 and oxidation resistant case 26 contain the cell and serve as the negative and positive terminals, respectively. Electrode composition 12 (i.e., the cathode) is coated on foil current collector 16, for example, as described above. Likewise, positive electrode 14 according to the present invention (i.e., the anode) is coated on foil current collector 18 as described above. Separator 20, wetted with electrolyte is positioned as to prevent direct contact between the anode and the cathode. Gasket 27 provides a seal and separates the two terminals. Coin cells are usually assembled, by crimping, in an approximately “balanced” configuration, that is, with the negative electrode capacity equaling the positive electrode capacity.

Objects and advantages according to the present invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or Alfa Aesar, Ward Hill, Mass., or otherwise as specified.

### Example 1

Silicon powder (0.3 grams (g), Alfa Aesar, particle size=1-20 micrometers) and 1.4 g of MoSi₂ (Cerac Incorporated, Milwaukee, Wis., particle size=−325 mesh) were placed into a 30-milliliter (mL) planetary micro mill available as “PLANETARY MICRO MILL PULVERISETTE 7” from Fritsch, Idar-Oberstein, Germany, equipped with a tungsten carbide vessel and 51 g of 5 mm tungsten carbide milling media and milled for 1 hour at speed setting 6 under heptane. To this mixture was added 0.255 g of high surface area carbon available as “SUPER P” from Timcal, Brussels, Belgium. Polyimide precursor solution (0.85 g, 20 percent by weight solids in N-methylpyrrolidinone, NMP) available as “PYRALIN PJ2555” from HD Microsystems, Wilmington, Del., was then added to the solids mixture and an additional 3 g of NMP was added. The mill was then operated at speed setting 3 for 1 hour. The resulting dispersion was then coated onto a nickel foil current collector using a 5-mil (0.1-mm) notch bar, dried at 75° C. for 30 minutes and then heat treated at 200° C. for 1 hour and finally 250° C. for 1 hour to give an electrode composition that, based upon weight, was 14.1% Si, 65.9% MoSi₂, 12% high surface area carbon, and 8% polyimide. X-Ray analysis indicated that the Si and MoSi₂ particles in the electrode composition did not share a phase boundary.

Coin cells (type 2325) were then assembled using metallic lithium as the counter electrode. The electrolyte was a mixture of ethylene carbonate and diethyl carbonate in a 1:2 volume ratio. LiPF₆ was used as the conducting salt at 1 molar (M) concentration. The coin cells were cycled between 5 millivolts (mV) and 0.9 volts (V) vs. Li/Li⁺ at 718 milliamperes per gram (mA/g) based upon the amount of elemental silicon in the cell.

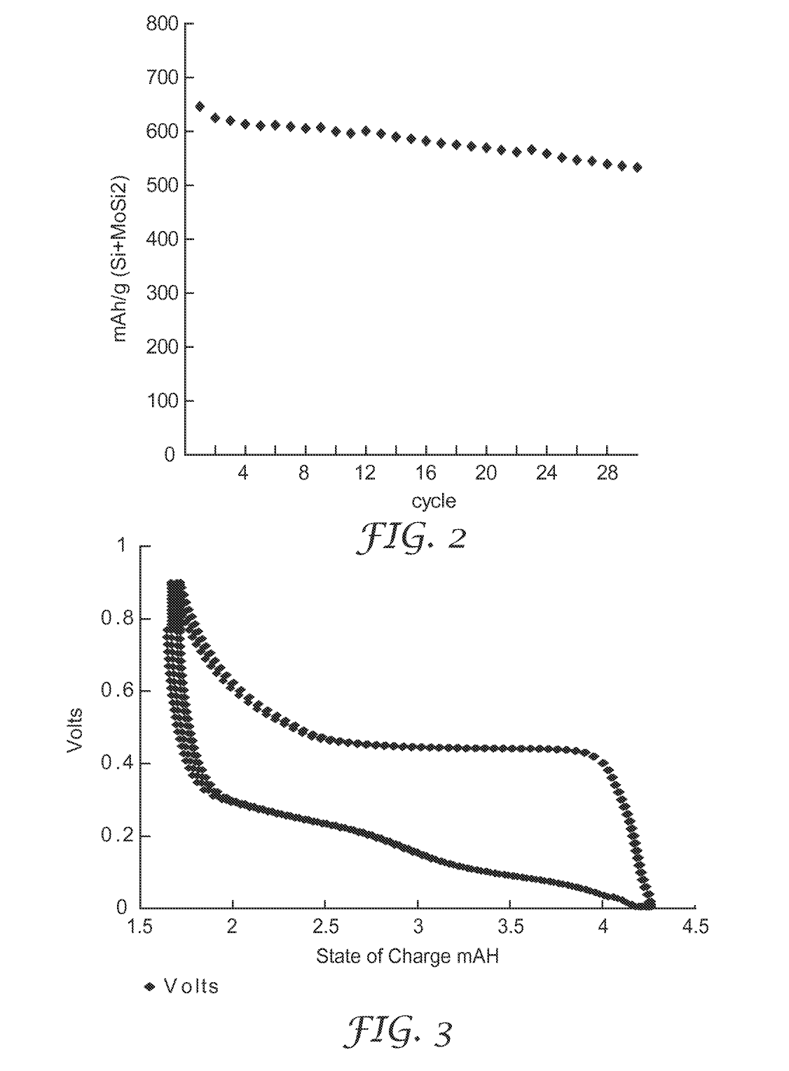

The specific capacity of the electrode composition of Example 1 is shown in FIG. 2 as a function of cycle number. FIG. 3 shows the capacity retention of the electrode composition of Example 1.

### Example 2

Silicon powder (0.3 g, Alfa Aesar, particle size=1-20 micrometers ) and 2.08 g of WSi₂ (Alfa Aesar, particle size=−325 mesh) were placed into a 30-mL planetary micro mill available as “PLANETARY MICRO MILL PULVERISETTE 7” from Fritsch, equipped with a tungsten carbide vessel and 51 g of 5 mm tungsten carbide milling media. The powders were milled to 2 hours at a speed of 10 under heptane. To this mixture was added 5.2 g of a 4.9 percent by weight dispersion of high surface area carbon available as “SUPER P” from Timcal in NMP along with 0.85 g of a polyimide precursor solution (20 percent by weight solids in NMP) available as “PYRALIN PJ2555” from HD Microsystems. The slurry was further mixed at a speed of 3 in the micro mill for an additional hour. The resulting slurry was coated onto nickel foil using a 5-mil (0.1-mm) notch bar. The coated electrode was dried at 70° C. for 30 minutes and then cured at 200° C. in air for one hour to give an electrode composition that, based upon weight, was 10.7% Si, 74.3% WSi₂, 8.9% high surface area carbon, and 6.1% polyimide. X-Ray analysis indicated that the Si and WSi₂ particles in the electrode composition did not share a phase boundary.

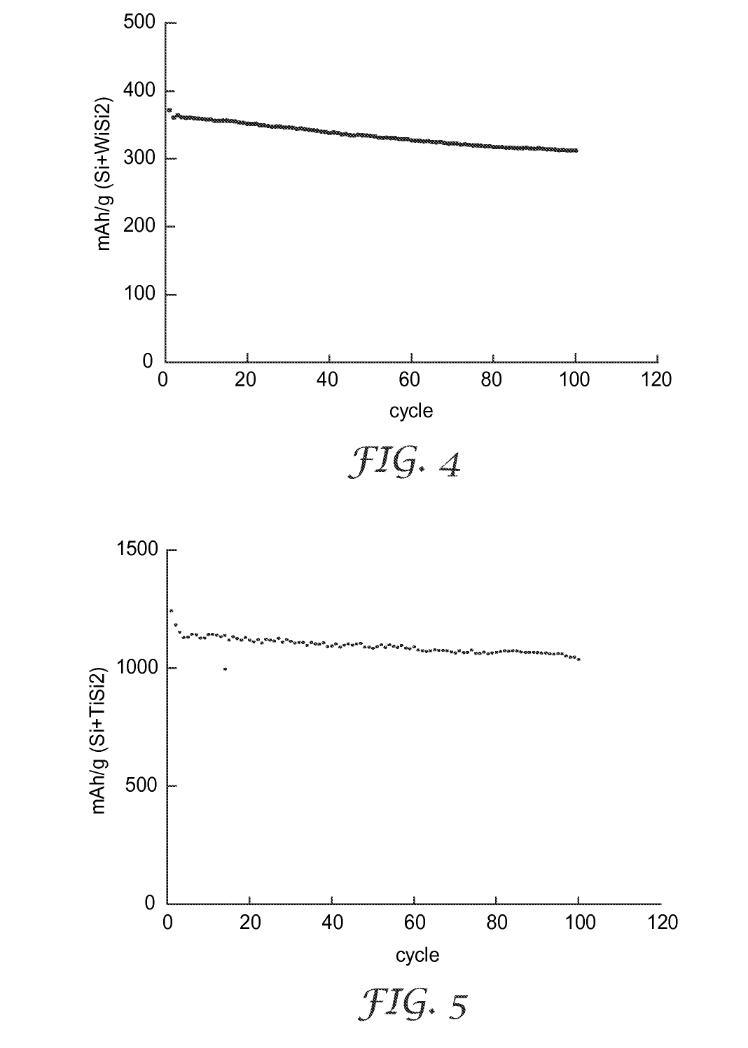

Coin cells (type 2325) were then assembled using metallic lithium as the counter electrode. The electrolyte was a mixture of ethylene carbonate and diethyl carbonate in a 1:2 volume ratio. LiPF₆ was used as the conducting salt at 1 M concentration. The coin cells were cycled between 5 mV and 0.9 V vs. Li/Li⁺ at 718 mA/g based upon the amount of elemental silicon in the cell. The specific capacity of the electrode composition of Example 2 is shown in FIG. 4 as a function of cycle number.

### Example 3

Silicon powder (0.3 g, Alfa Aesar, particle size=1-20 micrometers) and 2.08 g of TSi₂ (Alfa Aesar, particle size=−325 mesh) were placed into a 30-mL planetary micro mill available as “PLANETARY MICRO MILL PULVERISETTE 7” from Fritsch, equipped with a tungsten carbide vessel and 51 g of 5 mm tungsten carbide milling media. The powders were milled to 2 hours at a speed of 10 under heptane. To this mixture was added 5.2 g of a 4.9 percent by weight dispersion of high surface area carbon available as “SUPER P” from Timcal in NMP along with 0.85 g of a polyimide precursor solution (20 percent by weight solids in NMP) available as “PYRALIN PJ2555” from HD Microsystems. The slurry was further mixed at a speed of 3 in the micromill for an additional hour. The resulting slurry was coated onto nickel foil using a 5-mil (0.1-mm) notch bar. The coated electrode was dried at 70° C. for 30 minutes and then cured at 200° C. in air for one hour to give an electrode composition that, based upon weight, was 18.8% Si, 55.0% WSi₂, 15.6% high surface area carbon, and 10.6% polyimide. X-Ray analysis indicated that the Si and WSi₂ particles in the electrode composition did not share a phase boundary.

Coin cells (type 2325) were then assembled using metallic lithium as the counter electrode. The electrolyte was a mixture of ethylene carbonate and diethyl carbonate in a 1:2 volume ratio. LiPF₆ was used as the conducting salt at 1 M concentration. The coin cells were cycled between 5 mV and 0.9 V vs. Li/Li⁺ at 718 mA/g based upon the amount of elemental silicon in the cell. The specific capacity of the electrode composition of Example 3 is shown in FIG. 5 as a function of cycle number.

### Example 4

Silicon powder (3.0 g, Alfa Aesar, particle size=1-20 micrometers) and 5.3 g of TiN (Alfa Aesar, particle size=<3 micrometers) were placed into a 30-mL planetary micro mill available as “PLANETARY MICRO MILL PULVERISETTE 7” from Fritsch, equipped with a tungsten carbide vessel and 47 g of 0.65 mm ZrO₂ milling media. The powders were milled to 2 hours at a speed of 10 under heptane. The heptane was removed by drying at 75° C. To 2.0 g of the dried mixture was added 0.21 g of a 4.9 percent by weight dispersion of high surface area carbon available as “SUPER P” from Timcal in NMP along with 0.71 g of a polyimide precursor solution (20 percent by weight solids in NMP) available as “PYRALIN PJ2555” from HD Microsystems. An additional 4.1 g of NMP was also added. The slurry was further mixed at a speed of 3 in the micromill for an additional hour using of 2-15 mm WC balls. The resulting slurry was coated onto nickel foil using a 5-mil (0.1-mm) notch bar. The coated electrode was dried at 70° C. for 30 minutes and then cured at 200° C. in air for one hour to give an electrode composition that, based upon weight, was 30.6% Si, 54.4% TiN, 8.9% high surface area carbon, and 6.0% polyimide. X-Ray analysis indicated that the Si and TiN particles in the electrode composition did not share a phase boundary.

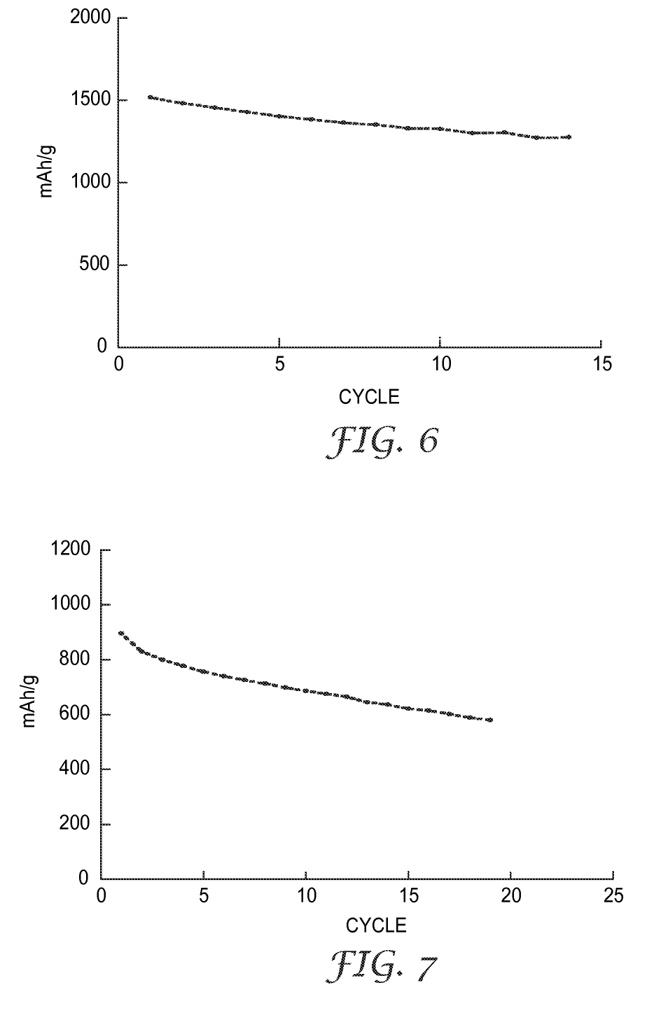

Coin cells (type 2325) were then assembled using metallic lithium as the counter electrode. The electrolyte was a mixture of ethylene carbonate and diethyl carbonate in a 1:2 volume ratio. LiPF₆ was used as the conducting salt at 1 M concentration. The coin cells were cycled between 5 mV and 0.9 V vs. Li/Li⁺ at 718 mA/g based upon the amount of elemental silicon in the cell. The specific capacity of the electrode composition of Example 4 is shown in FIG. 6 as a function of cycle number.

### Example 5

Silicon powder (1.5 g, Alfa Aesar, particle size=1-20 micrometers) and 3.35 g of Cu powder (Aldrich, Cat. No. 203122) were placed into a 30-mL planetary micro mill available as “PLANETARY MICRO MILL PULVERISETTE 7” from Fritsch, equipped with a tungsten carbide vessel and 20 g of 0.65 mm ZrO₂ milling media. The powders were milled to 2 hours at a speed of 10 under heptane. The heptane was removed by drying at 75° C. To 1.0 g of the dried mixture was added 0.12 g of a 4.9 percent by weight dispersion of high surface area carbon available as “SUPER P” from Timcal in NMP along with 0.3 g of a polyimide precursor solution (20 percent by weight solids in NMP) available as “PYRALIN PJ2555” from HD Microsystems. An additional 4.0 g of NMP was also added. The slurry was further mixed at a speed of 3 in the micromill for an additional hour using of 2-15 mm WC balls. The resulting slurry was coated onto nickel foil using a 5-mil (0.1-mm) notch bar. The coated electrode was dried at 70° C. for 30 minutes and then cured at 200° C. in air for one hour to give an electrode composition that, based upon weight, was 26% Si, 59% Cu, 10% high surface area carbon, and 5% polyimide. X-Ray analysis indicated that the Si and Cu particles in the electrode composition did not share a phase boundary.

Coin cells (type 2325) were then assembled using metallic lithium as the counter electrode. The electrolyte was a mixture of ethylene carbonate and diethyl carbonate in a 1:2 volume ratio. LiPF₆ was used as the conducting salt at 1 M concentration. The coin cells were cycled between 5 mV and 0.9 V vs. Li/Li⁺ at 718 mA/g based upon the amount of elemental silicon in the cell. The specific capacity of the electrode composition of Example 5 is shown in FIG. 7 as a function of cycle number.

Various modifications and alterations of this invention may be made by those skilled in the art without departing from the scope and spirit of this invention, and it should be understood that this invention is not to be unduly limited to the illustrative embodiments set forth herein.

What is claimed is:

1. An electrode composition for a lithium ion battery comprising:
a binder comprising polyimide and having dispersed therein:
electrochemically active particles;
metallic conductive diluent particles that are not electrochemically active, wherein the electrochemically active particles and the conductive diluent particles do not share a common phase boundary; and
non-metallic conductive diluent particles,
wherein the electrochemically active particles and the metallic conductive diluent particles are present in a molar ratio in a range of from greater than zero and less than or equal to 3.

2. An electrode composition according to claim 1, wherein the electrochemically active particles comprise silicon.

3. An electrode composition according to claim 1, wherein the electrochemically active particles consist essentially of silicon.

4. An electrode composition according to claim 1, wherein the electrochemically active particles have an average particle size in a range of from 0.5 to 1.5 micrometers.

5. An electrode composition according to claim 1, wherein the metallic conductive diluent particles have an average particle size in a range of from 0.5 to 1.5 micrometers.

6. An electrode composition according to claim 1, wherein the metallic conductive diluent particles are selected from the group consisting of tungsten silicide particles, titanium silicide particles, molybdenum silicide particles, copper particles, and combinations thereof.

7. An electrode composition according to claim 1, wherein the non-metallic conductive diluent particles comprise high surface area carbon.

8. An electrode composition according to claim 1, wherein the electrochemically active particles and the metallic conductive diluent particles are present in a molar ratio of from 0.5 to 1.5.

9. An electrode composition according to claim 1, wherein the polyimide comprises an aromatic polyimide.

10. A lithium ion battery comprising:
an anode comprising an electrode composition according to claim 1;
a cathode; and
electrolyte separating the anode and cathode.

11. A method of making an electrode composition, the method comprising:
a) providing components comprising:
electrochemically active particles;
metallic conductive diluent particles that are not electrochemically active, wherein the electrochemically active particles and the conductive diluent particles do not share a common phase boundary; and
non-metallic conductive diluent particles;
wherein the electrochemically active particles and the metallic conductive diluent particles are present in a molar ratio in a range of from greater than zero and less than or equal to 3; and
b) dispersing the components in a binder comprising polyimide.

12. A method of making an electrode composition according to claim 11, wherein the electrochemically active particles comprise silicon.

13. A method of making an electrode composition according to claim 11, wherein the electrochemically active particles consist essentially of silicon.

14. A method of making an electrode composition according to claim 11, wherein the electrochemically active particles have an average particle size in a range of from 0.5 to 1.5 micrometers.

15. A method of making an electrode composition according to claim 11, wherein the metallic conductive diluent particles have an average particle size in a range of from 0.5 to 1.5 micrometers.

16. A method of making an electrode composition according to claim 11, wherein the conductive diluent particles are selected from the group consisting of tungsten silicide particles, titanium silicide particles, molybdenum silicide particles, copper particles, and combinations thereof.

17. A method of making an electrode composition according to claim 11, wherein the non-metallic conductive diluent particles comprise high surface area carbon.

18. A method of making an electrode composition according to claim 11, wherein the electrochemically active particles and the metallic conductive diluent particles are present in a molar ratio of from 0.5 to 1.5.

19. A method of making an electrode composition according to claim 11, wherein the polyimide comprises an aromatic polyimide.
